(19) United States
(12) Patent Application Publication
(10) Pub. No.: US 2023/0308283 A1
(43) Pub. Date: Sep. 28, 2023

(54) BLOCKCHAIN PROGRAM VERIFICATIONS

(71) Applicant: Hewlett-Packard Development Company, L.P., Spring, TX (US)

(72) Inventors: Jose Luis Abad Peiro, Sant Cugat del Valles (ES); Alberto Such Vicente, Sant Cugat del Valles (ES)

(21) Appl. No.: 17/701,397

(22) Filed: Mar. 22, 2022

(51) Int. Cl. H04L 9/32; G06F 8/61

(52) U.S. Cl. CPC H04L 9/3234; G06F 8/61; H04L 9/3263; B29C 64/393

(57) ABSTRACT

Examples of devices are described. In some examples, an electronic device includes a processor to generate a public key associated with an installation of a program. In some examples, the electronic device includes a communication interface to instruct a computing device to create an identity block in a blockchain based on the public key. In some examples, the communication interface is to send program information to a verification device to produce a verification block associated with the identity block in the blockchain.

### BACKGROUND

Electronic technology has advanced to become virtually ubiquitous in society and has been used for many activities in society. For example, electronic devices are used to perform a variety of tasks, including work activities, communication, research, and entertainment. Different varieties of electronic circuitry may be utilized to provide different varieties of electronic technology.

### BRIEF DESCRIPTION OF THE DRAWINGS

FIG. 1 is a block diagram illustrating examples of an electronic device, a verification device, a computing device, and a linked device that may be utilized for some examples of blockchain program verifications;

FIG. 2 is a block diagram of an example of an electronic device that may be used in blockchain program verifications;

FIG. 3 is a block diagram illustrating an example of a computer-readable medium for blockchain program verifications;

FIG. 4 is a flow diagram illustrating an example of a method for blockchain program verifications; and

FIG. 5 is a thread diagram illustrating an example of blockchain program verification in accordance with some examples of the techniques described herein.

### DETAILED DESCRIPTION

Verifying proper installation, setup, or operation of a program on an arbitrary computer may be challenging because the computer may lack security hardware to root the trust of the program. In some scenarios, it may be helpful to verify proper installation, setup, or operation of a program running in an uncontrolled environment. For instance, verification may help cloud or Internet-based technology operate with enhanced security, results, or efficiency in conjunction with a program in an uncontrolled environment. As used herein, the term “uncontrolled environment” or “uncontrolled computer” may refer to scenarios where a computer, computing environment, or a combination thereof is privately operated (e.g., not controlled by a cloud entity, service provider, or other third party). Examples of some scenarios may include cloud or Internet-based printing (e.g., three-dimensional (3D) printing) approaches. In some approaches, a program (e.g., agent program) running on a computer in a private network (e.g., local area network (LAN)) may interact with a printer and provide front-end processing to the printer. The computer may not be controlled by the printer provider, though the printer in the cloud may rely on the program to perform operations for the printer, gather data from the printer, or a combination thereof.

In some scenarios (e.g., print service provider (PSP) environments), printers may be managed by a program (e.g., front end or raster image processor (RIP)) running on a computer. It may be helpful to verify the program to perform some operations (e.g., security-implicated operations) to enhance cloud printing performance.

Some approaches to establish a trusted computer may rely on a security hardware component (e.g., a trusted platform module (TPM) circuit or other custom security circuit) that stores a private key and an associated certificate signed by a trusted certification authority in the computer for use by a program. In some scenarios, where a program is running on an uncontrolled computer, the computer may lack (or not use) a security hardware component to identify and trust a program. Some mechanisms to identify to the computer (e.g., issuing a hypertext transfer protocol secure (https) certificate based on an Internet protocol (IP)) may be unusable, because the IP address of the computer is not controlled by the service provider, and the computer may be located behind network address translation (NAT) or a proxy.

Some examples of the techniques described herein provide external verification of a program(s). In some examples, a blockchain or blockchains may be utilized to manage identification of a program, verification of the program, or a combination thereof.

Throughout the drawings, similar reference numbers may designate similar or identical elements. When an element is referred to without a reference number, this may refer to the element generally, without limitation to any particular drawing or figure. In some examples, the drawings are not to scale or the size of some parts may be exaggerated to more clearly illustrate the example shown. Moreover, the drawings provide examples in accordance with the description. However, the description is not limited to the examples provided in the drawings.

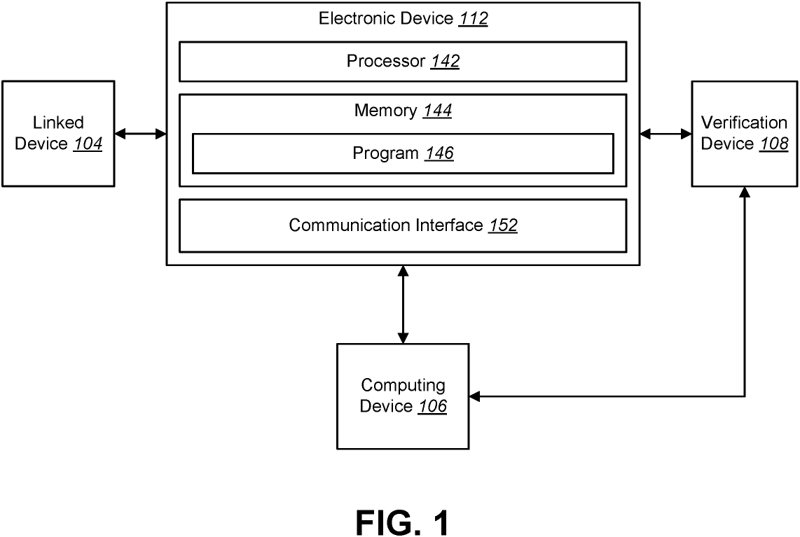

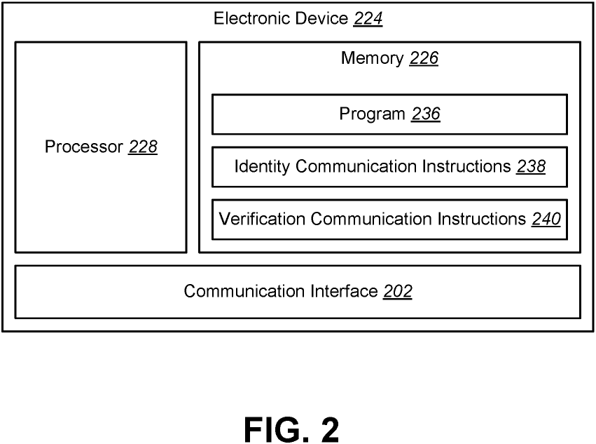

FIG. 1 is a block diagram illustrating examples of an electronic device 112, a verification device 108, a computing device 106, and a linked device 104 that may be utilized for some examples of blockchain program verifications. In some examples, the electronic device 112, verification device 108, computing device 106, linked device 104, or a combination thereof may perform an operation or operations described in FIG. 2. For instance, the electronic device 112 may be an example of the electronic device 224 described in FIG. 2.

An electronic device (e.g., electronic device 112) is a device that includes electronic circuitry (e.g., integrated circuitry, etc.). Examples of an electronic device include a computer (e.g., laptop computer, desktop computer, etc.), server, smartphone, tablet device, game console, automation controller, network device, etc. The electronic device 112 includes a processor 142, a memory 144, and a communication interface 152. The processor 142, memory 144, and communication interface 152 may be examples of corresponding components described in FIG. 2. For instance, the electronic device 112 may utilize the communication interface 152 to communicate with the computing device 106, the verification device 108, the linked device 104, or a combination thereof. In some examples, the electronic device 112 may communicate with the computing device 106, the verification device 108, the linked device 104, or a combination thereof via a wired connection(s), a wireless connection(s), or a combination thereof.

The memory 144 may include (e.g., store) a program 146. The program 146 is a set of executable instructions. For example, the program 146 may be an application, driver, agent, or a combination thereof. The electronic device 112 (e.g., processor 142) installs the program 146. Installing the program 146 may include storing the program 146 in the memory 144, storing a library (e.g., library file(s), dynamic linked library, .dll, etc.), updating a registry (e.g., storing registry key(s), modifying registry key(s), etc.), listing the program 146 as installed, or a combination thereof. For instance, the electronic device 112 may receive (e.g., download) the program 146 from another device (e.g., network device, server, etc.) or may receive the program 146 from removable storage (e.g., a universal serial bus (USB) thumb drive, optical media, external hard drive, etc.). In some examples, the processor 142 may execute an installation routine to install the program 146.

The processor 142 generates a cryptographic key associated with the installation of the program 146. The cryptographic key may be an asymmetric key. For instance, the processor 142 generates a public key, a private key, or a combination thereof associated with the installation of the program 146. Key generation may be associated with the installation of the program 146 by being part of the program 146 installation routine, by being performed with the initial execution of the program 146, or a combination thereof. For instance, installing the program 146 may produce the cryptographic key(s). In some examples, the processor 142 executes the program 146 to create a cryptographic key or keys. In some examples, the processor 142 executes instructions separate from the program 146 to create the cryptographic key(s). The electronic device 112 (e.g., communication interface 152) may send the cryptographic key(s) to the computing device 106.

In some examples, the electronic device 112 may send further information to the computing device 106. For instance, the communication interface 152 may send an address (e.g., IP address, NAT information, or a combination thereof) of the electronic device 112 to the computing device 106. In some examples, the communication interface 152 may send a version indicator (e.g., version number) of the program 146 to the computing device 106. In some examples, the communication interface 152 may send a platform indicator (e.g., operating system (OS) identifier, hardware indicator, or a combination thereof) of the electronic device 112 to the computing device 106. For instance, a platform indicator may indicate an OS of the electronic device 112, may indicate a hardware component(s) (e.g., processor 142 type, motherboard type, graphics card type, memory 144 type, hardware performance metric(s) such as processor 142 clock speed, processor 142 load, memory 144 consumption, etc., or a combination thereof) of the electronic device 112, or a combination thereof.

The computing device 106 includes a processor(s) and instructions stored in a memory or memories (not shown in FIG. 1). The processor(s) may execute instructions (e.g., smart contract(s)) to perform an operation(s) described herein. In some examples, the computing device 106 may include a communication interface (not shown in FIG. 1) to communicate with the electronic device 112, the verification device 108, or a combination thereof. In some examples, the computing device 106 (e.g., computing device(s), server(s), storage device(s), etc.) may store a blockchain (e.g., ledger). A blockchain is a data structure that includes a block or series of blocks. A block is data (e.g., a set of data). For example, a block may include a hash (e.g., cryptographic hash, SHA-256, etc.) of a previous block and a record (e.g., ledger record). For instance, a record (e.g., ledger record) may include data indicating an event (e.g., program installation, etc.), timestamp, etc. In some examples, a record may be hashed (e.g., stored as a hash tree). In some examples, a blockchain may represent a ledger (e.g., a series of records).

In some examples, multiple computing devices may be utilized. For instance, multiple blockchain nodes may be utilized to perform an operation or operations described in relation to the computing device 106. In some examples, multiple computing devices may be utilized to execute a smart contract, add a block (e.g., identity block, verification block, transaction record, etc.) to a blockchain, store a ledger, or a combination thereof. For instance, multiple blockchain nodes may be involved in the execution of a smart contract (e.g., miner nodes in a blockchain may execute a smart contract(s) to confirm a block(s) added by the computing device 106). In some examples, a blockchain (e.g., ledger) may provide a history of verifications that can be accessed, providing confirmation capabilities. For instance, a remote device may check what the verification status was at a certain time, when an operation was performed.

The electronic device 112 (e.g., communication interface 152) may instruct the computing device 106 to create an identity block in a blockchain based on the cryptographic key (e.g., public key). For instance, the communication interface 152 may send the public key to the computing device 106 to produce an identity block that includes the public key in a blockchain. An identity block is a block of a blockchain that identifies an installation, a program, or a combination thereof. For instance, the public key (e.g., asymmetric cryptographic key) associated with the installation of the program may identify the installation, the program, or a combination thereof. In some examples, the identity block may include a timestamp indicating a time when the installation occurred or a time when the installation was recorded in the blockchain.

A smart contract is a set of instructions to add to the blockchain. In some examples, the computing device 106 may store and execute a smart contract to add the identity block. In some examples, the same smart contract may be utilized for multiple electronic devices, programs, or a combination thereof. In some examples, the electronic device 112 (e.g., processor 142) may generate a smart contract and the communication interface 152 may send the smart contract to the computing device 106. For instance, a smart contract may be generated for each program, for each electronic device, or for a combination thereof. In some examples, the computing device 106 may execute the smart contract from the electronic device 112 to produce the identity block.

In some examples, the identity block may include the address (e.g., IP address, NAT information, or a combination thereof) of the electronic device 112. In some examples, the identity block may include the version indicator (e.g., version number) of the program 146. In some examples, the identity block may include the platform indicator (e.g., OS identifier, hardware indicator, or a combination thereof) of the electronic device 112. For instance, the computing device 106 may create the identity block (e.g., record) including the address, version indicator, platform indicator, or a combination thereof. In some examples, the blockchain may be distributed among multiple computing devices (e.g., servers), copied to multiple computing devices, or a combination thereof.

The verification device 108 may be an electronic device to verify program installation, setup, operation, or a combination thereof. For example, the verification device 108 may include a processor(s) and instructions stored in a memory or memories (not shown in FIG. 1). The processor(s) may execute the instructions to perform an operation(s) described herein. In some examples, the verification device 108 may include a communication interface (not shown in FIG. 1) to communicate with the electronic device 112, the computing device 106, or a combination thereof.

Performing verification of a program may include confirming that the program is installed (e.g., was installed successfully), that the program is setup with a target setup (e.g., the program has target settings), that the program operates in accordance with a criterion, or a combination thereof. In some examples, the electronic device 112, the verification device 108, the computing device 106, or a combination thereof performs verification. For instance, the electronic device 112 may send program information to the verification device 108 to produce a verification block associated with the identity block in the blockchain. A verification block is a block that attests to (e.g., verifies, confirms, etc.) an aspect of a program (e.g., program installation, setup, operation, integrity of a cryptographic key, etc.). In some examples, verification of the program 146 may be performed without security hardware. For instance, the electronic device 112 may lack a security circuit (e.g., TPM circuit, etc.) or may perform verification without using a security circuit (e.g., TPM circuit, etc.).

Program information is information regarding the installation of a program, information regarding the setup of the program, information regarding the operation of the program, or a combination thereof. For instance, the electronic device 112 (e.g., communication interface 152) may send an installation indicator (e.g., list of installed programs) of the program 146 to the verification device 108. The verification device 108 may check the installation indicator to confirm that the program 146 is installed.

In some examples, the electronic device 112 (e.g., communication interface 152) may send setup indicator (e.g., setting(s), setup parameter(s), etc.) of the program 146 to the verification device 108. The verification device 108 may check the setup indicator to confirm that the program 146 is setup according to a target setup. For instance, the verification device 108 may utilize platform information, hardware information, or a combination thereof (received from the computing device 106, for example) to determine whether the program 146 is setup in accordance with a target setup for the program 146 on the indicated platform, with the indicated hardware, or a combination thereof.

In some examples, the electronic device 112 (e.g., communication interface 152) may send an operation indicator (e.g., operation input, operation output, or a combination thereof) of the program 146 to the verification device 108. The verification device 108 may check the operation indicator to confirm that the program 146 is operating according to an operation criterion. For instance, the processor 142 may execute the program 146 with an operation input to produce an operation output. The communication interface 152 may send the operation output to the verification device 108, which may determine whether the operation output matches a target output (corresponding to the operation input, for instance).

In some examples, the verification device 108 may send a challenge message to the electronic device 112. The communication interface 152 may receive the challenge message from the verification device 108. The program information may be sent in response to the challenge message. For instance, the challenge message may indicate a command to provide an installation indicator, setup indicator, operation indicator, or a combination thereof. In some examples, the challenge message may include an operation input. In an example where the program 146 is a printer agent or printer driver, for instance, the challenge message may indicate an operation input of a 3D object model to format for printing (e.g., to produce build slice(s), printing fluid map(s), contone map(s), object packing, or a combination thereof) to produce an operation output. The communication interface 152 may send the operation output (e.g., build slice(s), contone map(s), object packing, or a combination thereof) to the verification device 108, which may determine whether the operation output satisfies a criterion (e.g., packing characteristic, contone map accuracy, slice accuracy, etc.).

The verification device 108 may instruct the computing device 106 to produce a verification block. For instance, the verification device 108 may send an instruction to the computing device 106 to produce a verification block in response to successful verification of the program 146. If the criterion (e.g., installation check, target set, operation criterion, or a combination thereof) is met, for example, the verification device 108 may instruct the computing device 106 to add a verification block (in association with the identity block) to the blockchain.

In some examples, the verification device 108 generates a cryptographic key associated with the verification of the program 146. The cryptographic key may be an asymmetric key. For instance, the verification device 108 generates a second public key, a second private key, or a combination thereof associated with the verification of the program 146. Key generation may be associated with the verification of the program 146 by being part of the program 146 verification routine, by being performed in response to a successful verification of the program 146, or a combination thereof. For instance, verifying the program 146 may produce the second cryptographic key(s). In some examples, the verification device 108 creates the second cryptographic key or keys to attest the verification of the program 146, to produce an authenticity claim of the program 146, or a combination thereof. The electronic device 112 (e.g., communication interface 152) may send the second cryptographic key(s) to the computing device 106.

The computing device 106 may generate the verification block. For instance, the computing device 106 may generate the verification block in response to receiving the instruction from the verification device 108. The computing device 106 may add the verification block to the blockchain. In some examples, the verification block includes a second public key of the verification device 108.

In some examples, a remote device (not shown in FIG. 1) may communicate with the electronic device 112, the computing device 106, or a combination thereof (over a network(s), for instance). A remote device is a device (e.g., computer, server smartphone, tablet device, etc.) that is separate from (e.g., physically separate, distinct, distanced from, etc.) the electronic device 112, computing device 106, verification device 108, linked device 104, or a combination thereof. For instance, a remote device may communicate with the electronic device 112, the computing device 106, or a combination thereof over the Internet, a LAN, or a combination thereof. In some examples, the remote device may validate that a verification block for the program 146 is stored in the blockchain. In some examples, the remote device may utilize the identity block (e.g., public key) from the blockchain to establish a secure communication channel (e.g., encrypted communication channel) with the electronic device 112 (e.g., program 146).

In some examples, the program 146 is an agent. An agent is a program to perform an operation for another device. For example, the program 146 may be an agent to perform an operation related to a linked device 104. In some examples, the program 146 (e.g., agent) is a printer agent on the electronic device 112 to control a printer (e.g., inkjet printer, laser printer, 3D printer, etc.). For instance, the linked device 104 may be a printer that may be controlled by the electronic device 112 (e.g., processor 142 executing the program 146). In some examples, the program 146 may be a RIP to produce a raster image for printing from a file (e.g., document, image). In some examples, the program 146 may produce data in a format for printing (e.g., build slice(s), printing fluid map(s), contone map(s), object packing, or a combination thereof) from a 3D object model(s). The program 146 may be an example of the program 236 described in FIG. 2.

The linked device 104 may be an electronic device that is linked to (e.g., in communication with) the electronic device 112. In some examples, the linked device 104 may include a processor(s) and instructions stored in a memory or memories (not shown in FIG. 1). The processor(s) may execute the instructions to perform an operation(s) described herein. In some examples, the linked device 104 may include a communication interface (not shown in FIG. 1) to communicate with the electronic device 112. Examples of the linked device 104 may include a printer (e.g., two-dimensional (2D) printer, inkjet printer, laser printer, 3D printer, etc.), computer, server, peripheral device (e.g., monitor, mouse, keyboard, external storage device, virtual reality (VR) headset, etc.), television, audio/video (A/V) receiver, or a combination thereof. For instance, the linked device 104 may be a printer including a printhead(s), nozzle(s), reservoir(s), build bed(s), heat source(s) (e.g., heat lamp(s), laser(s), oven(s), etc.), or a combination thereof. The linked device 104 may communicate with the electronic device 112 via a wired link (e.g., USB link, Ethernet link, coaxial cable link, etc.), wireless link (e.g., Wi-Fi link, cellular link, Bluetooth link, etc.), or a combination thereof. In some examples, the linked device 104 may be linked to the electronic device 112 via a network or networks (e.g., Internet, LAN, etc.).

Some examples of the techniques described herein may provide different verification aspects, different levels of verification, or a combination thereof. For instance, different verification aspects or different levels of verification may be utilized for different operations. In an example where the program 146 is a RIP, for instance, the program 146 may be verified (e.g., attested) for correct color setup and profiling, the integrity of encryption keys, or a combination thereof. The communication interface 152 may send the program information (e.g., color setup information, color profiling information, or a combination thereof) and information regarding an encryption key(s) to the verification device 108, which may determine whether the program information and encryption key integrity criteria are satisfied. In some examples, one remote device (e.g., cloud application) with a color accuracy target may check the blockchain (e.g., verification block) for verification (e.g., attestation) of color setup and profiling, while another remote device (e.g., art printing application to produce limited edition prints) may check the blockchain (e.g., verification block) for verification (e.g., attestation) of color setup and profiling and of encryption key integrity.

FIG. 2 is a block diagram of an example of an electronic device 224 that may be used in blockchain program verifications. The electronic device 224 may be a computing device, such as a personal computer, a server computer, a printer, a 3D printer, a smartphone, a tablet computer, etc. The electronic device 224 includes a processor 228, a memory 226, a communication interface 202, or a combination thereof. In some examples, the electronic device 224 may be in communication with (e.g., coupled to, have a communication link with) a computing device (e.g., a computing device that manages a blockchain), a verification device, a linked device, a remote device, or a combination thereof. In some examples, the electronic device 224 may include additional components (not shown) or some of the components described herein may be removed or modified without departing from the scope of the disclosure.

The processor 228 may be any of a central processing unit (CPU), a semiconductor-based microprocessor, graphics processing unit (GPU), field-programmable gate array (FPGA), an application-specific integrated circuit (ASIC), other hardware device suitable for retrieval and execution of instructions stored in the memory 226, or a combination thereof. The processor 228 may fetch, decode, and execute instructions stored on the memory 226. In some examples, the processor 228 may include an electronic circuit or circuits that include electronic components for performing a functionality or functionalities of the instructions. In some examples, the processor 228 may perform one, some, or all of the aspects, elements, techniques, etc., described in one, some, or all of FIGS. 1-5.

The memory 226 is an electronic, magnetic, optical, or other physical storage device that contains or stores electronic data (e.g., information, instructions, or a combination thereof). The memory 226 may be, for example, Random Access Memory (RAM), Electrically Erasable Programmable Read-Only Memory (EEPROM), a storage device, an optical disc, the like, or a combination thereof. In some examples, the memory 226 may be volatile memory, non-volatile memory, or a combination thereof. For instance, the memory 226 may be Dynamic Random Access Memory (DRAM), EEPROM, magnetoresistive random-access memory (MRAM), phase change RAM (PCRAM), memristor, flash memory, the like, or a combination thereof. In some examples, the memory 226 may be a non-transitory tangible machine-readable storage medium, where the term “non-transitory” does not encompass transitory propagating signals. In some examples, the memory 226 may include multiple devices (e.g., a RAM card and a solid-state drive (SSD)).

The processor 228 may utilize the communication interface 202 to communicate with an external device or devices (not shown). The communication interface 202 may include hardware, machine-readable instructions, or a combination thereof to enable the processor 228 to communicate with the external device or devices. The communication interface 202 may enable a wired connection(s), wireless connection(s), or a combination thereof to the external device or devices. In some examples, the communication interface 202 may include a network interface card, hardware, machine-readable instructions, or a combination thereof to enable the processor 228 to communicate with various input devices, output devices, or a combination thereof. Examples of input devices may include a keyboard, a mouse, a touchscreen, another electronic device, etc. In some examples, a user may input data into the electronic device 224 via an input device. Examples of output device may include a display, speaker, printer, another electronic device, etc.

The memory 226 may store a program 236, identity communication instructions 238, verification communication instructions 240, or a combination thereof. The program 236 described in FIG. 2 may be similar to the program 146 described in FIG. 1. For instance, the program 146 may be a RIP program to operate a printer linked to the electronic device 112. In some examples, the processor 228 installs the program 236 and executes the program 236 to generate a public key. In some examples, installing the program 236 and generating the public key may be performed as described in FIG. 1.

The processor 228 may execute the identity communication instructions 238 to communicate with an external device (e.g., computing device) to create an identity block associated with the program 236. For instance, the communication interface 202 may send an address of the electronic device 224 and the public key to a computing device to create an identity block including the address and the public key in a blockchain. In some examples, sending the address, sending the public key, creating the identity block with the address and the public key, or a combination thereof may be accomplished as described in FIG. 1.

The processor 228 may execute the verification communication instructions 240 to communicate with an external device (e.g., verification device) to perform a verification operation(s) associated with the program 236. For instance, the communication interface 202 may receive a message from a verification device. The message may be a request for program information, a challenge message, or a combination thereof, for instance. The communication interface 202 may send, in response to the message, program information to the verification device to produce a verification block associated with the identity block in the blockchain. In some examples, receiving the message, sending the program information, producing the verification block, or a combination thereof may be accomplished as described in FIG. 1.

In some examples, the communication interface 202 may receive a communication request including the public key from a remote device. For instance, the communication request may indicate a request to establish a secure communication channel for communication with the electronic device (e.g., program 236). In some examples, the processor 228 may validate an identity of the remote device to establish a secure communication channel with the remote device.

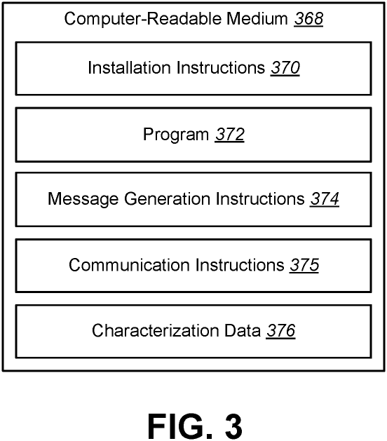

FIG. 3 is a block diagram illustrating an example of a computer-readable medium 368 for blockchain program verifications. The computer-readable medium 368 is a non-transitory, tangible computer-readable medium. The computer-readable medium 368 may be, for example, RAM, EEPROM, a storage device, an optical disc, and the like. In some examples, the computer-readable medium 368 may be volatile memory, non-volatile memory, or a combination thereof. For instance, the computer-readable medium 368 may be DRAM, EEPROM, MRAM, PCRAM, memristor, flash memory, the like, or a combination thereof. In some examples, the computer-readable medium 368 described in FIG. 3 may be a computer-readable medium of an electronic device described herein. In some examples, the computer-readable medium 368 may include data (e.g., information, instructions, or a combination thereof) to cause a processor to perform one, some, or all of the operations, aspects, elements, etc., of an electronic device described in one, some, or all of FIGS. 1-5.

The computer-readable medium 368 includes data (e.g., information, instructions, or a combination thereof). For example, the computer-readable medium 368 may include installation instructions 370, program 372, message generation instructions 374, communication instructions 375, characterization data 376, or a combination thereof.

The installation instructions 370 may include instructions when executed cause a processor of an electronic device to install a program 372 on the electronic device. In some examples, installing the program 372 may be performed as described in one, some, or all of FIGS. 1-5.

The message generation instructions 374 may include instructions when executed cause a processor of an electronic device to generate a first message including a public key, address, version indicator, and platform indicator. In some examples, generating the first message may be performed as described in FIG. 1. For instance, the processor may generate a public key as described herein, determine an address of the electronic device, determine a version indicator of the program 372, and determine a platform indicator (e.g., OS, hardware, etc.), which the processor may format into a message (e.g., packet(s)). In some examples, the electronic device may determine the address of the electronic device by querying an OS of the electronic device, may determine a version indicator of the program 372 by querying the program 372, may determine a platform indicator by querying the OS, or a combination thereof. In some examples, the address indicates NAT information of the electronic device. In some examples, the public key, address, version indicator, and platform indicator may be stored as characterization data 376, which may be retrieved by the processor to generate the first message.

The communication instructions 375 may include instructions when executed cause a processor of an electronic device to use a communication interface to send the first message to a computing device to create an identity block including the public key, address, version indicator, and platform indicator in a blockchain. In some examples, sending the first message and creating the identity block may be performed as described in one, some, or all of FIGS. 1-5.

The message generation instructions 374 may include instructions when executed cause a processor of an electronic device to generate a second message including program information. In some examples, generating the second message may be performed as described in FIG. 1. For instance, the processor may determine information regarding the installation of the program 372, information regarding the setup of the program 372, information regarding the operation of the program 372, or a combination thereof. In some examples, generating the second message may be performed in response to a message or challenge from a verification device.

The communication instructions 375 may include instructions when executed cause a processor of an electronic device to use a communication interface to send the second message to a verification device to produce a verification block associated with the identity block in the blockchain. In some examples, sending the second message may be performed as described in one, some, or all of FIGS. 1-5. In some examples, the verification block includes a second public key of the verification device.

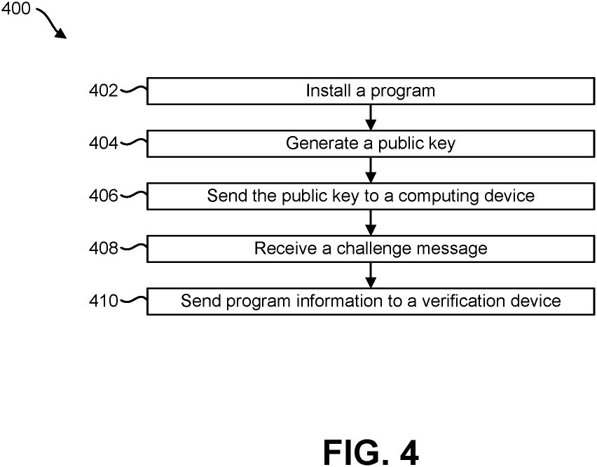

FIG. 4 is a flow diagram illustrating an example of a method 400 for blockchain program verifications. The method 400 or a method 400 element may be performed by an electronic device (e.g., electronic device 112, electronic device 224, etc.) described herein.

At 402, an electronic device may install a program. In some examples, the electronic device may install the program as described in one, some, or all of FIGS. 1-5.

At 404, the electronic device may generate a public key. In some examples, the electronic device may generate the public key as described in one, some, or all of FIGS. 1-5.

At 406, the electronic device may send the public key to a computing device. In some examples, the electronic device may send the public key as described in one, some, or all of FIGS. 1-5.

At 408, the electronic device may receive a challenge message. In some examples, the electronic device may receive the challenge message as described in one, some, or all of FIGS. 1-5. For instance, the electronic device may receive a challenge message from a verification device in accordance with a challenge/response protocol.

At 410, the electronic device may send program information to a verification device. For instance, the electronic device may send the program information as described in one, some, or all of FIGS. 1-5. In some examples, the electronic device may determine the program information as described in FIG. 1. Sending the program information may enable the verification device to verify the program and instruct the computing device to create a verification block.

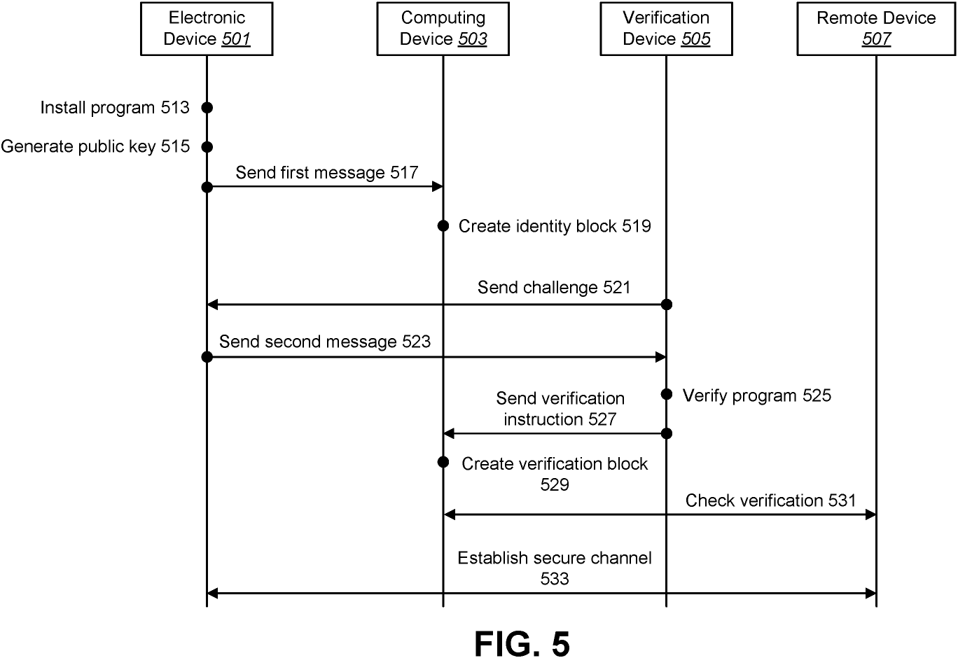

FIG. 5 is a thread diagram illustrating an example of blockchain program verification in accordance with some examples of the techniques described herein. FIG. 5 illustrates examples of an electronic device 501, a computing device 503, a verification device 505, and a remote device 507. In some examples, the electronic device 501, the computing device 503, and the verification device 505, may be respective examples of the electronic device 112, computing device 106, and verification device 108 described in FIG. 1.

Some examples of the techniques described herein may use a smart contract in a blockchain to track the identification and verification of a program on the electronic device 501. At 513, the electronic device 501 may install a program. In some examples, at installation, the electronic device 501 may create a smart contract. For instance, the electronic device 501 may create and send the smart contract to the computing device 503 (not shown in FIG. 5). In some approaches, the computing device 503 may utilize a smart contract without the electronic device 501 creating and sending a smart contract.

At 515, the electronic device 501 may generate a public key. For instance, at installation, the electronic device 501 may generate cryptographic key(s), including a public key (e.g., asymmetric key).

At 517, the electronic device 501 may send a first message. The first message may include the public key. In some examples, the first message may include additional information. For instance, the first message may include information (e.g., IP address, NAT routing information, etc.) to access the electronic device 501 (e.g., program) via a network. In some examples, the first message may include information (e.g., OS, hardware, program version, etc.) from the electronic device 501 where the program is running.

At 519, the computing device 503 may create an identity block based on the first message. For instance, the computing device 503 may execute a smart contract to add an identity block associated with the program to the blockchain.

In some examples, the verification device 505 may provide cloud-based verification (e.g., attestation) that the program is properly installed and setup. For instance, the verification device 505 may utilize an attestation mechanism or mechanisms for the verification. In some examples, an offline mechanism (not shown in FIG. 5) may be utilized based on a user (e.g., trusted operator) checking the installation at the electronic device 501. The user may review the installation and input an approval to the verification device 505 indicating that the program has been properly installed and setup. In some examples, an online mechanism may be utilized, where the verification device 505 contacts the electronic device 501 (e.g., program) with a challenge/response protocol to verify the installation and operation of the program. For instance, the verification device 505 may send a challenge to the electronic device 501 at 521.

At 523, the electronic device 501 may send a second message 523 to the verification device 505. The second message may include program information in response to the challenge. At 525, the verification device 505 may verify the program based on the program information in the second message. For instance, the verification device 505 may determine whether the program information satisfies a criterion or criteria for verification.

In a case that the verification device 505 verifies the program (e.g., the program is installed and set up correctly), the verification device 505 generates an asymmetric signature key to provide an authenticity claim about the correctness of the program. At 527, the verification device 505 sends a verification instruction 527 with a verification key (e.g., second public key, asymmetric signature key, etc.) to the computing device 503.

At 529, the computing device 503 creates a verification block in the blockchain. For instance, the computing device 503 may execute a smart contract to create the verification block including the verification key.

In some examples, a remote device 507 (or other application or hardware component, for instance) may communicate with the electronic device 501 (e.g., verified program). To communicate with the electronic device 501, the identity of the remote device 507 may be validated. In some examples, the remote device 507 may check the verification at 531. For instance, the remote device 507 may check that a verification block for the program is recorded in the blockchain (e.g., that an authenticity claim from the verification device 505 exists in association with the identity block of the program).

At 533, the remote device 507 and the electronic device 501 may establish a secure channel. For instance, the remote device 507 may use the public key from the verification block to initiate the establishment of a secure channel with the electronic device 501 (e.g., program). In some examples, a postcard protocol may be used for the secure communication.

In some examples, the validation of the electronic device 501 (e.g., program) may be mutual. For instance, each device participating in the communication may validate the identity of the other device(s) through this mechanism.

In some examples, the verification device 505 may occasionally (e.g., periodically) perform assessments of the program, through the online (e.g., challenge/response) mechanism, the offline mechanism (where a user verifies the correctness of the program, for instance), or a combination thereof. In some examples, the verification device 505 may use other approaches to assess the program, such as monitoring the program’s behavior and using heuristics or machine-learning based approaches to detect improper installation or setup.

In some approaches, compromise risk may also be utilized. In a case that the verification device 505 detects risk that the program has been compromised, the verification device 505 may cancel (e.g., negate, remove, etc.) the authenticity claim from the blockchain for the program. Canceling the authenticity claim may remove the trust on that program until the potential compromises have been addressed.

Some examples of the techniques described herein may be extended to support an ecosystem of verification components (e.g., verification devices) with different technologies, different levels of trust/security, or a combination thereof. Some examples of the techniques described herein do not rely on specific hardware in the electronic device where the program is installed. Blockchain may be utilized as a source of trust for the interconnection of different programs, electronic devices, or a combination thereof. Some examples of the techniques described herein may enable an ecosystem of program verification (with multiple electronic devices, computing devices, verification devices, remote devices, or a combination thereof, for instance).

As used herein, items described with the term “or a combination thereof” may mean an item or items. For example, the phrase “A, B, C, or a combination thereof” may mean any of: A (without B and C), B (without A and C), C (without A and B), A and B (without C), B and C (without A), A and C (without B), or all of A, B, and C.

While various examples are described herein, the described techniques are not limited to the examples. Variations of the examples are within the scope of the disclosure. For example, operation(s), aspect(s), or element(s) of the examples described herein may be omitted or combined.

What is claimed is:

1. An electronic device, comprising:
a processor to generate a public key associated with an installation of a program; and
a communication interface to:
instruct a computing device to create an identity block in a blockchain based on the public key; and
send program information to a verification device to produce a verification block associated with the identity block in the blockchain.

2. The electronic device of claim 1, wherein the program is a printer agent on the electronic device to control a three-dimensional (3D) printer linked to the electronic device.

3. The electronic device of claim 1, wherein a verification of the program is performed without security hardware.

4. The electronic device of claim 1, wherein the processor is to generate a smart contract and the communication interface is to send the smart contract to the computing device.

5. The electronic device of claim 1, wherein the communication interface is to send an address of the electronic device to the computing device, and wherein the identity block includes the address.

6. The electronic device of claim 1, wherein the communication interface is to send a version indicator of the program to the computing device, and wherein the identity block includes the version indicator.

7. The electronic device of claim 1, wherein the communication interface is to send a platform indicator of the electronic device to the computing device, and wherein the identity block includes the platform indicator.

8. The electronic device of claim 1, wherein the communication interface is to receive a challenge message from the verification device, and wherein the program information is sent in response to the challenge message.

9. The electronic device of claim 1, wherein the verification block includes a second public key of the verification device.

10. An electronic device, comprising:
a processor to install a program and execute the program to generate a public key; and
a communication interface to:
send an address of the electronic device and the public key to a computing device to create an identity block including the address and the public key in a blockchain;
receive a message from a verification device; and
send, in response to the message, program information to the verification device to produce a verification block associated with the identity block in the blockchain.

11. The electronic device of claim 10, wherein the program is a raster image processor (RIP) program to operate a printer linked to the electronic device.

12. The electronic device of claim 10, wherein:
the communication interface is to receive a communication request including the public key from a remote device; and
the processor is to validate an identity of the remote device to establish a secure communication channel with the remote device.

13. A non-transitory tangible computer-readable medium comprising instructions when executed cause a processor of an electronic device to:
install a program on the electronic device;
generate a first message including a public key, address, version indicator, and platform indicator;
use a communication interface to send the first message to computing device to create an identity block including the public key, the address, the version indicator, and the platform indicator in a blockchain; and
generate a second message including program information; and
use the communication interface to send the second message to a verification device to produce a verification block associated with the identity block in the blockchain.

14. The non-transitory tangible computer-readable medium of claim 13, wherein the verification block includes a second public key of the verification device.

15. The non-transitory tangible computer-readable medium of claim 13, wherein the address indicates network address translation (NAT) information of the electronic device.
